(19) United States
(12) Patent Application Publication
(10) Pub. No.: US 2009/0237759 A1
(43) Pub. Date: Sep. 24, 2009

(54) Display system for reproducing medical holograms

(76) Inventor: Michael Maschke, Lonnerstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/383,066

(22) Filed: Mar. 19, 2009

(30) Foreign Application Priority Data
Mar. 20, 2008 (DE) 10 2008 015 312.5

(51) Int. Cl. G03H 1/08; G03H 1/22

(52) U.S. Cl. 359/9; 359/32

(57) ABSTRACT

The invention relates to a display system for diagnostic image systems for reproducing three-dimensional medical images. The display system has at least one holographic projection facility that is connected to the diagnostic image system. The projection device reproduces a hologram of the three-dimensional medical images in an examination or intervention room.

### CROSS REFERENCE TO RELATED APPLICATIONS

This application claims priority of German application No. 10 2008 015 312.5 filed Mar. 20, 2008, which is incorporated by reference herein in its entirety.

### FIELD OF THE INVENTION

The invention relates to a display system for diagnostic image systems for reproducing three-dimensional medical images.

### BACKGROUND OF THE INVENTION

With serious illnesses, the changeover to minimally invasive therapies is becoming established as a replacement for surgical interventions.

One disease which most frequently results in death is vascular angiopathy, with the resulting diseases such as cardiac arrest or apoplexia. Cardiac arrest (myocardial infarction=MI) is caused by diseases in the coronary vessels. Here, arteriosclerotic plaques lead to thrombocyte activation and local thrombus formation. This may result in a total occlusion (“obstruction”) of the coronary vessels and thus in a blockage of the blood flow. The occlusion in the case of a cardiac arrest is nowadays treated in the majority of cases by a minimally invasive PTCA (Percutaneous Transiluminal Coronary Angioplasty). To this end, the constrictions in the coronary vessels are expanded using a “balloon catheter”.

A further example of the changeover from surgical to minimally invasive therapies becomes apparent in the case of the treatment of diseases in the cardiac valves. Until a few years ago cardiac valves were replaced by operating on an open heart. Such procedures involved mechanical or biological heart valve prostheses being implanted (aorta valves, pulmonary valves) or the existing valve opening being surgically reshaped (mitral valve or tricuspid valve). This was associated with high risks and extended convalescence periods of up to 6 weeks for patients. Methods which treat the heart valve stenosis in a minimally invasive fashion with the aid of special catheters have existed for a few years now.

The 3D representation of the organ to be treated is very significant in terms of a successful and low-risk minimally invasive therapy.

The disadvantage of the new minimally invasive methods is that they can only be implemented with the aid of fluoroscopy. This method previously only provided 2D images of the organs, for instance of the heart and of catheters or tools located there. A spatial assignment was thus almost impossible.

Further developments in x-ray image processing have led to 3D representations of vessels or cavities with the aid of a contrast agent.

The brochure “AXIOM Artis dFA DynaCT—A breakthrough in interventional 3D imaging” published by Siemens Medical Solutions, Order no. A91100-M1400-D159-10-7600, reference 91/4/6093 WS 04055, also discloses representing 3D soft tissue of non-moving organs using radiotechnology. A method of this type for generating 3D soft tissue is described in DE 10 2004 057 308 A1, the content of which is included in this description.

One clear advance was achieved with a C-arm x-ray device (CardDynaCT) which has just been developed, with which 3D soft tissue and optionally 3D high contrast exposures of the beating heart are possible by injecting contrast agent.

A method of this type is disclosed in DE 10 2005 016 472 A2 for instance, the content of which is included in this description.

All known solutions nevertheless represent the 3D x-ray exposures on 2D displays. The 3D image impression is achieved by volume rendering and rotating the 3D image with the aid of a mouse or joystick.

It is possible, with the aid of special eyeglasses, such as those with a polarization filter for example, to obtain a 3D image impression. This technique has however not be implemented in the field of medicine due to the additional eyeglasses.

3D displays, which manage without additional eyeglasses, are known from the company newsight for instance, see http://www.newsight.com.

DE 10 2006 010 971 A1 discloses a method for the autostereoscopic examination of images and an autostereoscopic arrangement.

With these solutions, the viewing directions of the observer are recorded and the polarization filter available in the display is controlled accordingly, so that a 3D image impression is produced. This solution is disadvantageous in that only one observer perceives the 3D image impression in each instance. Furthermore, the solution does not always operate reliably and has not become established within the field of medical therapy.

A display system described in DE 100 36 143 C2 for image systems for reproducing medical images, in which a beamer is used in the medical examination or intervention room instead of a display, nevertheless only allows 2D representations. In the as yet unpublished U.S. patent application Ser. No. 11/093,561, “Creating a Stereoscopic Image Pair From Two Different Image Sources, Using Image Registration” a stereoscopic image impression is possible with the aid of two beamers and special eyeglasses, which are worn by the observers. This solution is advantageous in that several observers can see the 3D exposures; otherwise the afore-cited disadvantages apply.

### SUMMARY OF THE INVENTION

The object underlying the invention is to embody a display system of the type mentioned in the introduction such that 3D image representations are enabled in the room at the correct position, i.e. directly adjacent thereto, and in the correct spatial orientation relative to the patient for a more rapid and reliable minimally invasive therapy.

The object is achieved in accordance with the invention in that at least one holographic projection facility is connected to the diagnostic image system, said projection facility reproducing a hologram of the medical three-dimensional images in an examination or intervention room.

The holographic projection facility may advantageously comprise a hologram unit for generating a hologram matrix, which generates control signals from a 3D data record for a connected hologram projector in order to represent a hologram.

In accordance with the invention, the hologram unit can be integrated into the diagnostic image system.

It has proven advantageous for the hologram unit to generate a hologram encoded in a hologram matrix and for the hologram matrix to be illuminated with coherent light by the hologram projector in order to reproduce the hologram.

The display system can be advantageously used in the case of one of the modalities of imaging systems from the group of Magnetic Resonance Imaging (MRI), X-rays, such as fluoroscopy and angiography, computed tomography, ultrasound, positron-emission tomography (PET), single-photon emission computed tomography (SPECT), optical methods and electromagnetically generated exposures for example.

Several projection facilities can advantageously be provided, which represent, superimpose and/or merge the exposures of a number of modalities of different hologram units in the examination or intervention room.

In accordance with the invention, the hologram may be a three-dimensional medical image of an organ or the vessel of the living being.

The object is also achieved in accordance with the invention by a method for reproducing three-dimensional medical images, in which a hologram of three-dimensional medical images is used for minimally invasive therapy, guidance and/or control.

### BRIEF DESCRIPTION OF THE DRAWINGS

The invention is described in more detail below with reference to exemplary embodiments shown in the drawing, in which;

FIG. 1 shows a known X-ray C-arm system with an industrial robot as a mounting device,

FIG. 2 shows a view of the path of a detector and a radiation source according to FIG. 1 about an object to be examined in an axial viewing direction,

FIG. 3 shows an intervention room with an inventive projection device and

FIG. 4 shows a circuit arrangement of an inventive x-ray diagnostic facility.

### DETAILED DESCRIPTION OF THE INVENTION

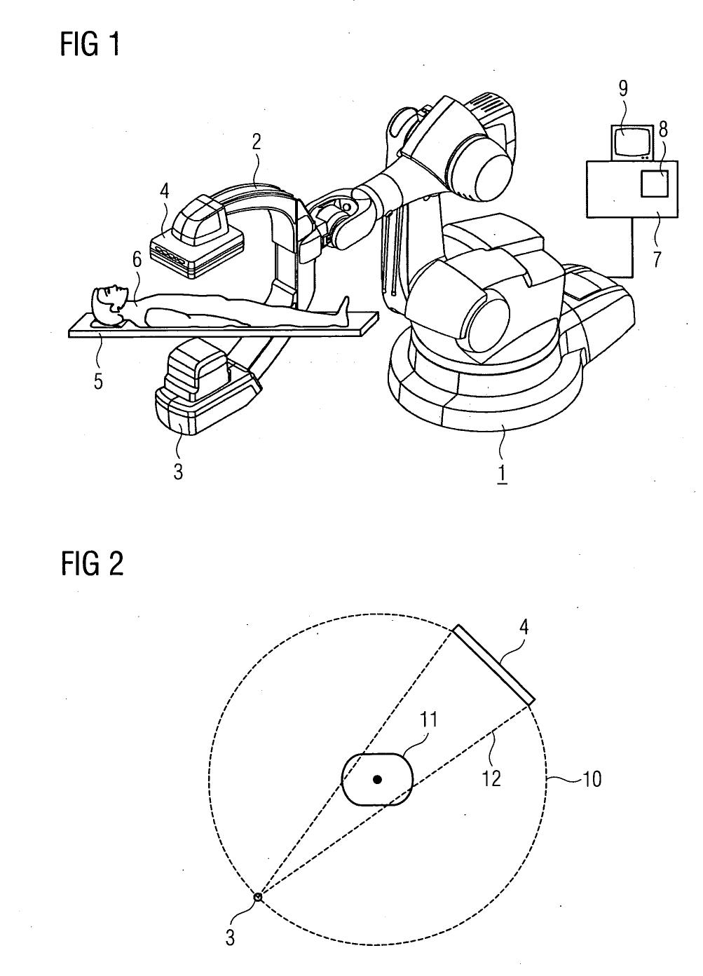

FIG. 1 shows an x-ray diagnostic facility, which comprises a C-arm 2 which is rotatably mounted on a stand in the form of an industrial robot 1, at the ends of which are attached an x-ray radiation source, for instance an x-ray emitter 3, and an x-ray image detector 4.

The x-ray image detector 4 may be a rectangular or square flat semiconductor detector, which is preferably created from amorphous silicon (a-Si).

A patient 6 to be examined is positioned in the radiation path of the x-ray emitter 3 on a patient support couch 5 for recording a heart for instance. A system control unit 7 with an image system 8 is connected to the x-ray diagnostic facility, said image system receiving and processing the image signals of the x-ray image detector 4. The x-ray images can then be observed on a monitor 9.

The industrial robot 1 known from DE 10 2005 012 700 A1 for instance, which preferably has six axes of rotation and thus six degrees of freedom, allows the C-arm 1 to be adjusted spatially in any fashion, for instance by it being rotated about a center of rotation between the x-ray emitter 3 and (including) the x-ray detector 4. The x-ray system 1 to 4 according to the invention is rotatable particularly about centers of rotation and axis of rotation in the plane of the x-ray image detector 4, preferably about the center point of the x-ray image detector 4 and about axes of rotation intersecting the center point of the x-ray image detector 4.

If 3D data records are to be created, the rotatably mounted C-arm 2 with the x-ray emitter 3 and x-ray image detector 4 is rotated such that, as shown in schematically in a top view onto the axis of rotation in FIG. 2, the x-ray emitter 3 shown here by its beam focus as well as the x-ray image detector move about an object 11 to be examined on a track 10. The track 10 may be passed through completely or partially in order to create a 3D data record.

The C-arm 2 comprising x-ray emitter 3 and x-ray image detector 4 preferably moves here about at least one angular range of 180°, for instance 180° plus fan angle, and records projection images from different projections in quick sequence. The reconstruction can only take place from a sub region of this recorded data.

The object 11 to be examined may be an animal or human body for instance but also a phantom body.

The x-ray emitter 3 emits a beam bundle 12 emanating from a radiation focus of its x-ray radiation source, said beam bundle striking the x-ray image detector 4.

The x-ray emitter 3 and the x-ray image detector 4 each move around the object 5 such that the x-ray emitter 3 and the x-ray image detector 4 lie opposite to one another on opposite sides of the object 11.

During normal radiography or fluoroscopy using an x-ray diagnostic facility of this type, the medical 2D data of the x-ray image detector 4 is buffered in the image system 8 and then reproduced on the monitor 9.

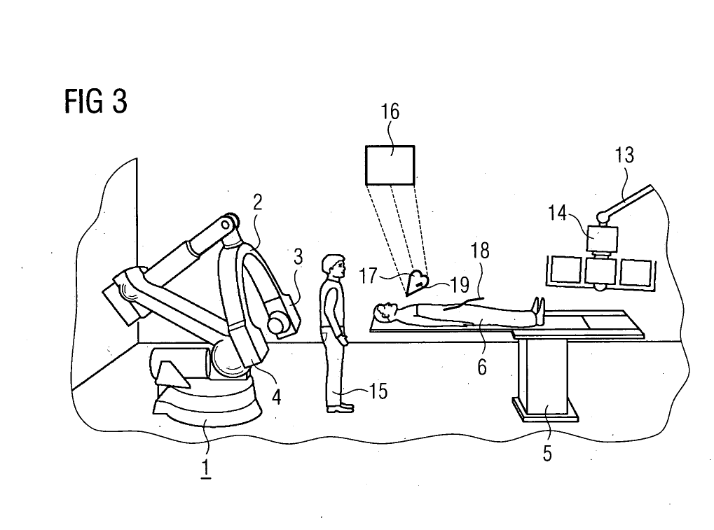

FIG. 3 shows an examination or intervention room with the x-ray diagnostic facility according to FIG. 1, which comprises a C-arm 2 which is rotatably mounted on an industrial robot 1 including an x-ray emitter 3 and an x-ray image detector 4. The patient 6 to be examined is positioned on the patient support couch 5. A rotatable and pivotable monitor array 14, consisting of a matrix of a number of flat panel displays, is held by a stand 13. An examiner or operating person 15, for instance a doctor, is positioned at the head end of the patient support couch 5 and can observe the patient 6 and the monitor array 14 with the flat panel displays.

In accordance with the invention, a hologram projector 16 is attached to the wall of the examination or intervention room for instance and projects a hologram 17 of the 3D data record created of the 3D image of the heart as described previously above. The hologram projector 16 may however also be mounted on a support, such as a stand or an array arm for example, on the ceiling, on the wall or on the floor.

An intracardiac catheter 18 can be inserted into the patient 6, the catheter tip 19 of which is reproduced in the hologram 17.

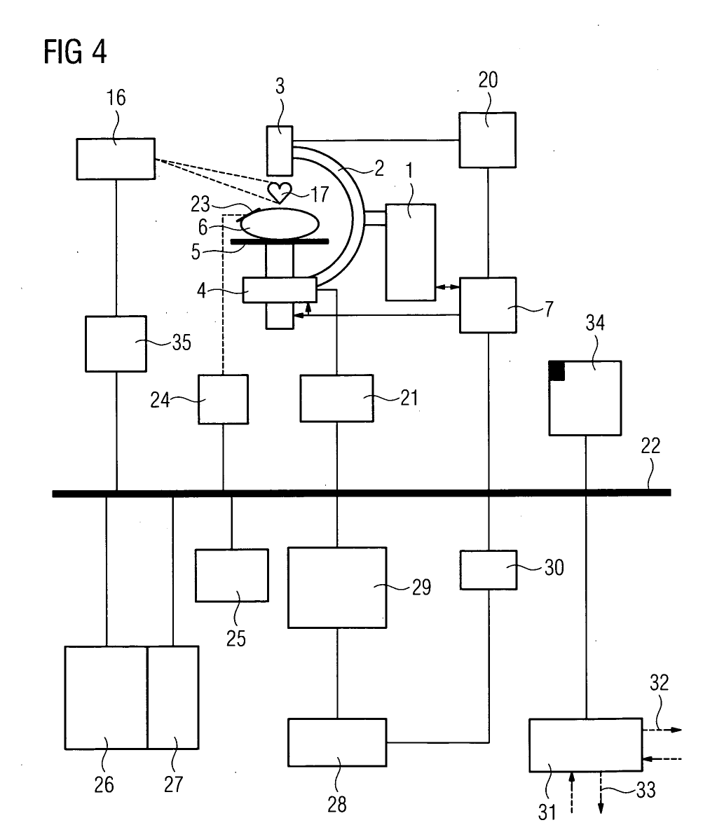

The circuit arrangement of the x-ray diagnostics facility is shown in more detail in FIG. 4.

A high voltage generator 20 is connected to the system control unit 7 and powers the x-ray emitter 3. The system control unit 7 is also connected to the x-ray image detector 4, for instance the aSi-flat panel detector, for the synchronous control of the x-ray emitter 3, if the x-ray image detector 4 is ready to take photos. The system control unit 7 likewise controls the rotary motors of the C-arm 2 which are accommodated in the industrial robot which is only shown symbolically as a stand here and records the feedback of the position of the C-arm 2.

The image data read out from the x-ray image detector 4 is processed in a pre-processing unit 21 and fed to a system data bus 22 for further distribution. The system control unit 7 and the pre-processing unit 21 may be part of an image system. They may also be realized as separate hardware or software.

Physiological sensors are attached to the patient 6 located on a patient support couch 5 in the beam path of the x-ray emitter 3, said sensors being ECG electrodes 23 and/or respiration sensors (not shown) for instance. These ECG electrodes 23 are connected to a physiological signal processing unit 24.

The image data of the signals of the x-ray image detector 4 processed by means of the pre-processing unit 21 are fed to an image processing unit 25 for x-ray images with a 3D and soft tissue processor by way of the system databus 22. A 2D-3D display unit 26 forms a reproduction unit with an input unit 27 (USER I/O).

A correction unit 28 for image artifacts and images is also connected to an image merging unit 29. The output signals thereof are fed to the 2D-3D display unit 26 for three-dimensional reproduction by way of an image merging unit 29, which effects a segmentation, auto-segmentation, registration and reconstruction.

A calibration unit 30 is also connected to the system databus 22, which is connected to the correction unit 28 for image artifacts and images.

A DICOM interface 31 for patient and image data is outwardly connected to the system data bus 22 for communication purposes, said DICOM interface 31 exchanging patient data by way of data lines with the HIS 33 and exchanging image data by way of additional data lines 33 by means of the intranet of the hospital or by way of the internet. Image data from other modalities, such as CT or MR exposures for example, can also be retrieved by way of the data lines 33.

An image data memory 34 is also connected to the system databus 22, said image data memory effecting a buffering of the image data supplied by the pre-processing unit 21, so that it can then be retrieved by the image processing unit 25 and/or forwarded by way of the DICOM interface 31.

A hologram unit 35 is connected to the system databus 22 for 3D reproduction for instance, said hologram unit generating control signals from the calculated 3D data record for a connected hologram projector 16, so that the hologram 17 of the organ to be treated is reproduced at the correct site, i.e. directly adjacent thereto and in the correct spatial orientation relative to the patient.

In accordance with the invention, a holographic 3D image representation is used in the room for the medical 3D imaging, in particular in the case of minimally invasive medical interventions.

In this way, a PC-based technology can be advantageously used, which is known for instance from SEEREAL TECHNOLOGIES S.A. (http://www.seereal.com/) for HDTV applications and is described in
US 2006/0050340 A1, “Method and Device for Encoding and Reconstructing Computer-Generated Video Holograms”, and
DE 10 2005 023 743 A1, “Projektionsvorrichtung und Verfahren zur holographischen Rekonstruktion von Szenen”, [Projection device and method for the holographic reconstruction of scenes], the content of which is included in the description.

A further advantage is the representation, for instance in 3D, of an organ to be treated in direct vicinity to and in the correct spatial orientation relative to the patient.

In a first embodiment, the hologram is generated using a separate computing unit.

In a further embodiment, the computing unit is integrated in order to generate the hologram into the medical imaging system, in particular x-ray imaging system.

The following medical modalities can be represented in 3D using the hologram unit 35 and the hologram projector 16:

Magnetic Resonance Imaging (MRI)

X-rays, such as fluoroscopy and angiography for example

Computed tomography (CT)

Ultrasound

Positron Emission Tomography (PET)

Single Photon Emission Computed Tomography (SPECT)

Optical methods, such as endoscopy and COT for example

Electromagnetically generated exposures, for instance “Magnetic Tracking”

In a further embodiment, exposures of a number of modalities of different hologram units in the examination or intervention room can be represented or also superimposed and/or merged. To this end, image data of the other modalities is loaded via the data lines 33 and is converted into holograms 17 by means of hologram unit 35 and is reproduced by means of a hologram projector 16. Here several hologram units 35 and hologram projectors 16 can also be used.

In an exemplary embodiment, components of the device include at least one x-ray tube, a radiation shutter, a patient support couch, a digital image system for fluoroscopy and angiography exposures, a 3D image processing unit, a hologram unit, a hologram projector, a system controller, an x-ray generator and an x-ray detector.

The advantage of the device is a more realistic 3D image representation in the room for a more rapid and reliable minimally invasive therapy.

1.-13. (canceled)

14. A display system for a diagnostic image system for reproducing a three-dimensional medical image of an object, comprising:
a holographic projection device connected to the diagnostic image system that reproduces a hologram of the medical three-dimensional image in an examination room.

15. The display system as claimed in claim 14, wherein the holographic projection device comprises a hologram unit for generating a hologram matrix.

16. The display system as claimed in claim 15, wherein the holographic projection device comprises a hologram projector connected to the hologram unit for reproducing the hologram.

17. The display system as claimed in claim 16, wherein the hologram unit generates a control signal from a 3D data record of the object for the hologram projector.

18. The display system as claimed in claim 16, wherein the hologram unit generates the hologram encoded in the hologram matrix that is illuminated with a coherent light by the hologram projector for reproducing the hologram.

19. The display system as claimed in claim 15, wherein the hologram unit is integrated in the diagnostic image system.

20. The display system as claimed in claim 14, wherein the diagnostic imaging system is selected from the group consisting of: magnetic resonance imaging, x-ray, computed tomography, ultrasound, positron-emission tomography, single-photon-emission tomography, optical method, and electromagnetically generated exposure.

21. The display system as claimed in claim 20, wherein a plurality of projection devices are provided in the examination room that represent, superimpose, or merge exposures of a plurality of different imaging systems of a plurality of different hologram units.

22. The display system as claimed in claim 14, wherein the object is an organ of a living being

23. The display system as claimed in claim 14, wherein the object is a vessel of a living being.

24. A method for reproducing a three-dimensional medical image of an object, comprising:
connecting a holographic projection device to the diagnostic image system; and
reproducing a hologram of the medical three-dimensional image in an examination room by the holographic projection device.

25. The method as claimed in claim 24, wherein the hologram is used for a minimally-invasive therapy.

26. The method as claimed in claim 24, wherein the hologram is used for guiding or controlling an examination.

27. A display system having a holographic projection device connected to a diagnostic image system for reproducing a three-dimensional medical image of an object, comprising:
a hologram unit that generates a hologram matrix and a control signal from a 3D data record of the object; and
a hologram projector connected to the hologram unit that reproduces a hologram of the three-dimensional medical image of the object in an examination room based on the hologram matrix and the control signal.

28. The display system as claimed in claim 27, wherein the hologram unit is integrated in the diagnostic image system.

29. The display system as claimed in claim 27, wherein the diagnostic imaging system is selected from the group consisting of: magnetic resonance imaging, x-ray, computed tomography, ultrasound, positron-emission tomography, single-photon-emission tomography, optical method, and electromagnetically generated exposure.
